(19) United States
(12) Patent Application Publication
(10) Pub. No.: US 2014/0142995 A1
(43) Pub. Date: May 22, 2014

(54) TICKET TRANSFER PAYMENT SYSTEM AND METHOD

(71) Applicant: Vendini, Inc., San Francisco, CA (US)

(72) Inventors: Marco Matarazzi, Gualdo Tadino (IT); Andrea Sprega, Gualdo Tadino (IT)

(73) Assignee: Vendini, Inc., San Francisco, CA (US)

(21) Appl. No.: 14/050,220

(22) Filed: Oct. 9, 2013

Related U.S. Application Data
(60) Provisional application No. 61/711,642, filed on Oct. 9, 2012.

(51) Int. Cl. G06Q 10/02; G06Q 20/10

(52) U.S. Cl. CPC G06Q 10/02; G06Q 20/10
USPC 705/5

(57) ABSTRACT

A ticket transfer is initiated from a user to a recipient by way of a ticketing application. The user specifies a payment amount for the ticket transfer. The ticketing application receives payment information from the recipient and processes the payment before transferring the ticket to the user.

### RELATED APPLICATIONS

The present application claims priority to U.S. provisional application No. 61/711,642, filed Oct. 9, 2012, the disclosure of which is incorporated by reference.

### BACKGROUND

1. Field of the Invention

The present invention generally concerns event ticket purchasing and processing. More particularly, the present invention relates to payment for transferred tickets.

2. Description of the Related Art

Traditionally, a paper ticket is issued and sold for each available seat at a live event or performance such as a concert, movie, ballet, or sporting event. A party wishing to attend the event is usually tasked with finding an available ticket, purchasing the ticket, receiving the purchased ticket (i.e., via e-mail, mail, or will call), and presenting the ticket to gain entry into the event. A problem may arise when a party wants to purchase multiple tickets for a group of attendees or when the attendee holds an issued ticket to an event but can no longer attend. When an attendee has purchased multiple tickets for a group of attendees, for example, the attendee is faced with the hassle of physically distributing the tickets to the attendees and, if applicable, collecting payment from each attendee for the same, both of which may involve a considerable amount of time, travel, and logistical planning. A similar situation occurs when the attendee can no longer attend the event. To prevent the ticket from going unused, the attendee can transfer a purchased event ticket from one party to another using a ticketing application. The transferor, however, may wish to receive payment for the transferred ticket. Therefore, there remains a need for an improved system and method for transferring funds from the transferor to the transfer recipient.

### SUMMARY OF THE CLAIMED INVENTION

A ticket transfer application starts a ticket transfer from one user to another. The user who owns the ticket sets a payment amount for the ticket. The user who is receiving the ticket enters payment information, such as bank account or credit card information. Once the payment information has been received, the application processes the payment. If payment is successful, the ticket is transferred. If payment is not successful, the ticket is not transferred.

### BRIEF DESCRIPTION OF THE FIGURES

FIG. 1 illustrates a computer-implemented method for payment of transferred tickets;

FIG. 2A illustrates an exemplary graphical interface for initiating a ticket transfer from a user to a recipient;

FIG. 2B illustrates an exemplary graphical interface for entering a payment amount for the ticket transfer;

FIG. 2C illustrates an exemplary graphical interface for entering recipient payment information;

FIG. 2D illustrates an exemplary graphical interface for displaying ticket transfer information;

FIG. 3 illustrates a computing system that may be used to implement the method of the present invention.

### DETAILED DESCRIPTION

Embodiments of the present invention provide a system and method for ticket transfer payment.

The steps of the method of the present invention may be embodied in hardware or software including a non-transitory computer-readable storage medium (e.g., an optical disc or memory card) having instructions executable by a processor of a computing device. A user may launch or activate the method by opening or activating an application for hosting electronic tickets (a “ticketing application”) in a computing device such as a mobile device. A ticketing application may be implemented by one or more processors that execute instructions stored in memory media. The executed code may result in the processor(s) generating one or more graphical interfaces. The steps of the method of the present invention may be used in conjunction with any ticketing application.

One or more tickets to an event may be electronically purchased by a user associated with a computing device. The purchased tickets may be digital, e-tickets, or print-at-home tickets (e.g., PDF, HTML, etc.). The event may be any private or public prerecorded, repeat, or live event or performance known in the art such as a concert, sporting event, show, movie, or musical recital. A purchased ticket may be electronically received by the user from the ticket seller or source and saved to a database accessible by the computing device. In another embodiment, a ticket may be received from another user of a ticketing application who has purchased the ticket. The user may choose to load or import one or more received tickets into an application for hosting electronic tickets and accessible by the computing device.

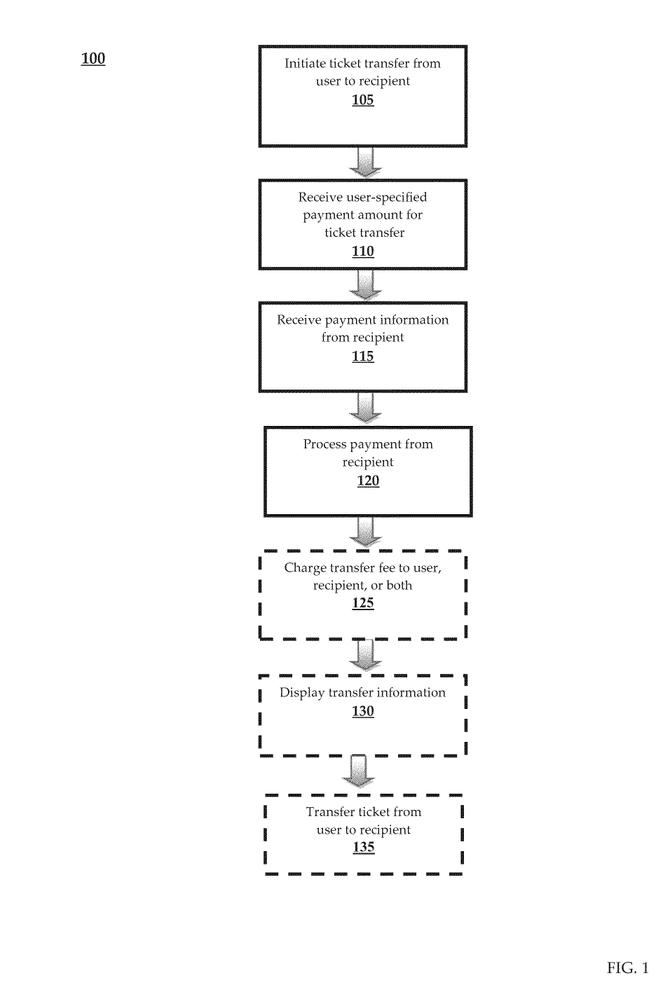

FIG. 1 illustrates a computer-implemented method for payment of transferred tickets. After the ticketing application initiates a ticket transfer from the user to a transfer recipient at step 105 of FIG. 1, a user may specify a payment amount from the transfer recipient in exchange for a ticket at step 110 of FIG. 1. In one embodiment of the present invention, a user may specify a payment amount for a ticket. In another embodiment, a user may choose from a pre-defined list of payment amounts.

The user may be required to provide information to allow incoming payments to be transferred to the user through the ticketing application, including, for example, a bank account number and routing number. In an exemplary embodiment of the present invention, when a user requests payment in exchange for a ticket, the transfer recipient may be required to enter payment information into the ticketing application. Such payment information may include, for example, bank account number, routing number, credit card number, credit card expiration date, and credit card security number (CVV/VCV). The transfer recipient may enter payment information and authorize payment to the user.

The recipient payment information is received by the ticketing application at step 115 of FIG. 1. At step 120 of FIG. 1, the ticketing application may then process payment from the transfer recipient to the user at step and deposit the payment into the bank account of the user.

Optionally, at step 125 of FIG. 1, in addition to the ticket transfer payment, the ticketing application may charge a fee for the ticket and payment transfer services. The fee may be, for example, a percentage of the total payment amount transferred from the transfer recipient to the user. Alternatively, the fee may be a set fee for each ticket (e.g., $0.99 per ticket). The ticketing application may charge this transfer fee to the transfer recipient, the user, or both the transfer recipient and the user.

At optional step 130 of FIG. 1, the ticketing application may also display other transfer information before or after processing the payment, including, for example, the amount requested by the user, the amount of any transfer fee, the amount of any credit card fee, the total amount owed by the transfer recipient to the user, and the name of the user to whom payment is authorized.

Following successful payment to the user, the system may transfer the electronic ticket to the transfer recipient at optional step 135 of FIG. 1. If the ticketing application is unable to complete the payment transfer, the ticket transfer may be aborted.

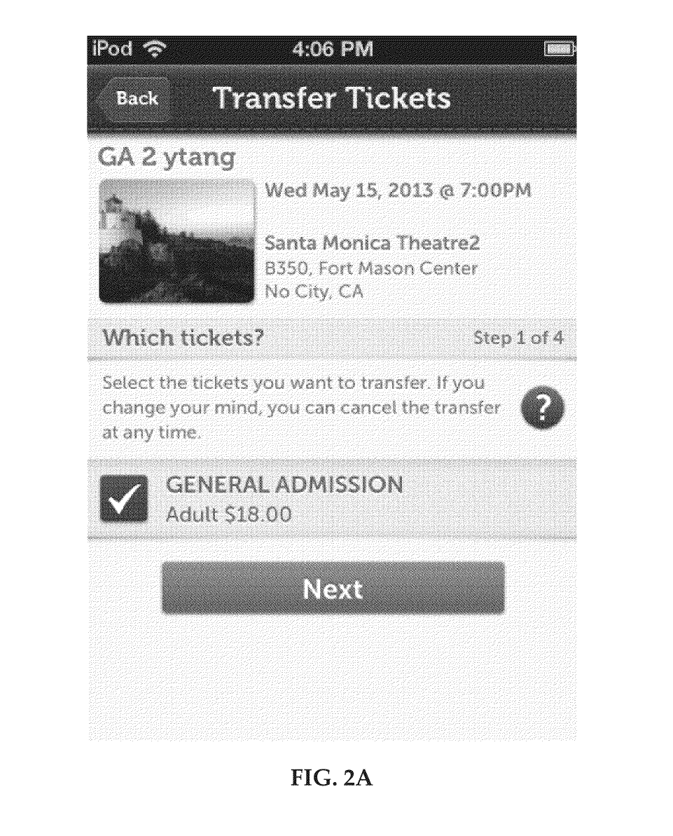

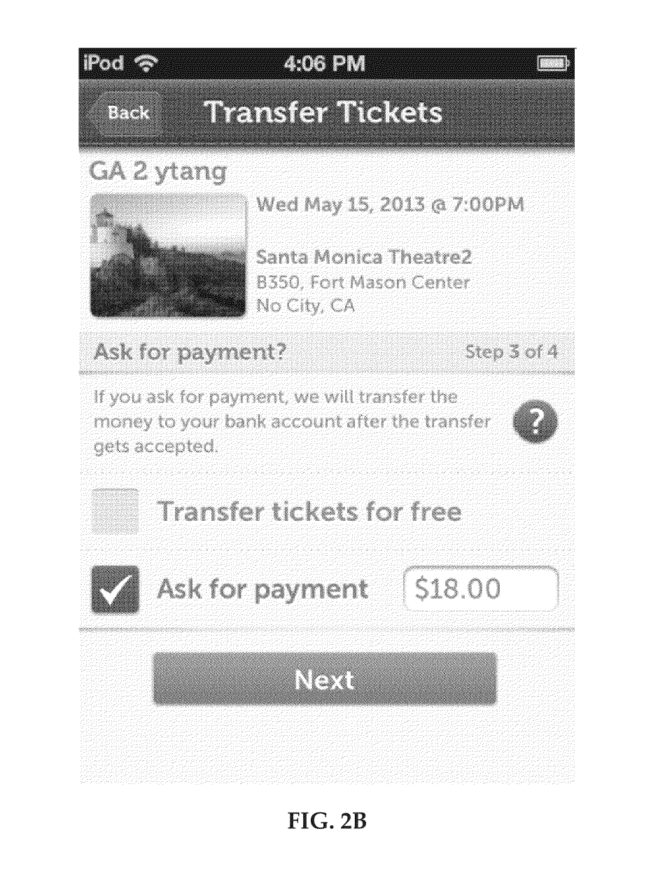

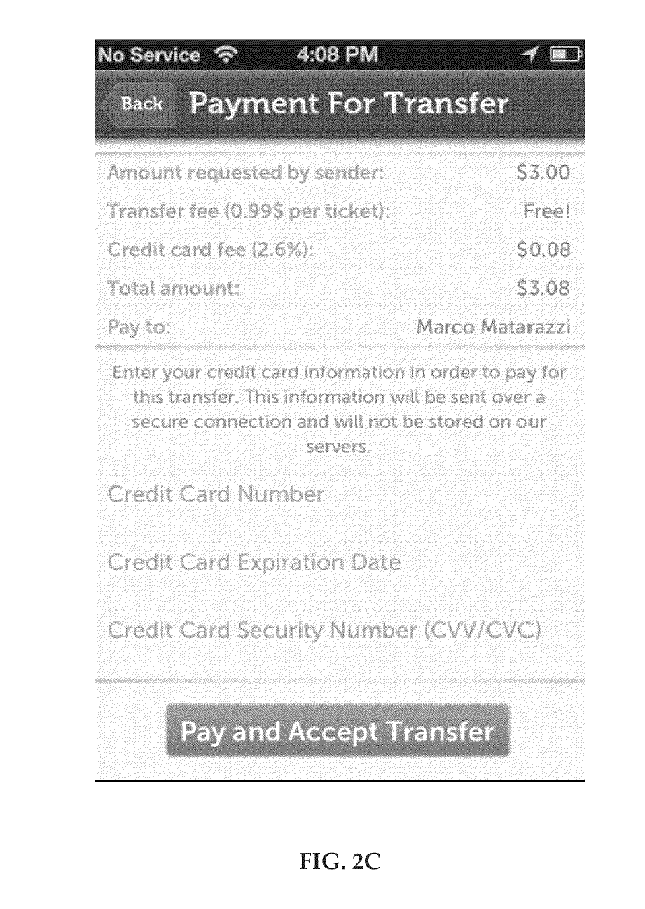

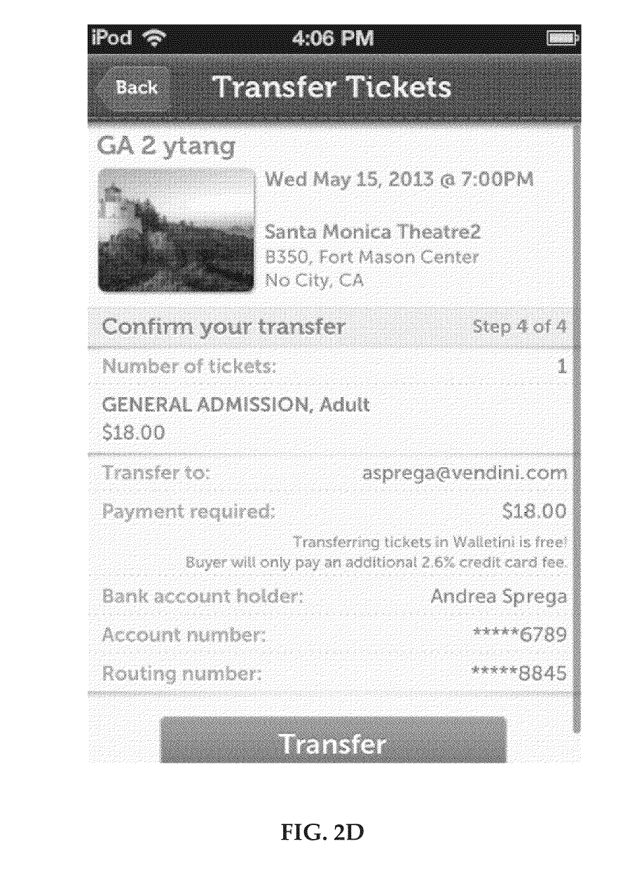

FIGS. 2A-2D illustrate exemplary interfaces for payment for transferred tickets, as described in step 100 of FIG. 1.

FIG. 2A illustrates an exemplary graphical interface for initiating a ticket transfer from a user to a recipient, as described in step 105 of FIG. 1. The user may select one or more tickets for a selected event to transfer.

FIG. 2B illustrates an exemplary graphical interface for entering a payment amount for the ticket transfer, as described in step 110 of FIG. 1. The payment amount may be specified by the user or selected form a list of pre-defined payment amounts (not shown).

FIG. 2C illustrates an exemplary graphical interface for entering recipient payment information, as described in step 115 of FIG. 1.

FIG. 2D illustrates an exemplary graphical interface for displaying ticket transfer information, as described in step 130 of FIG. 1.

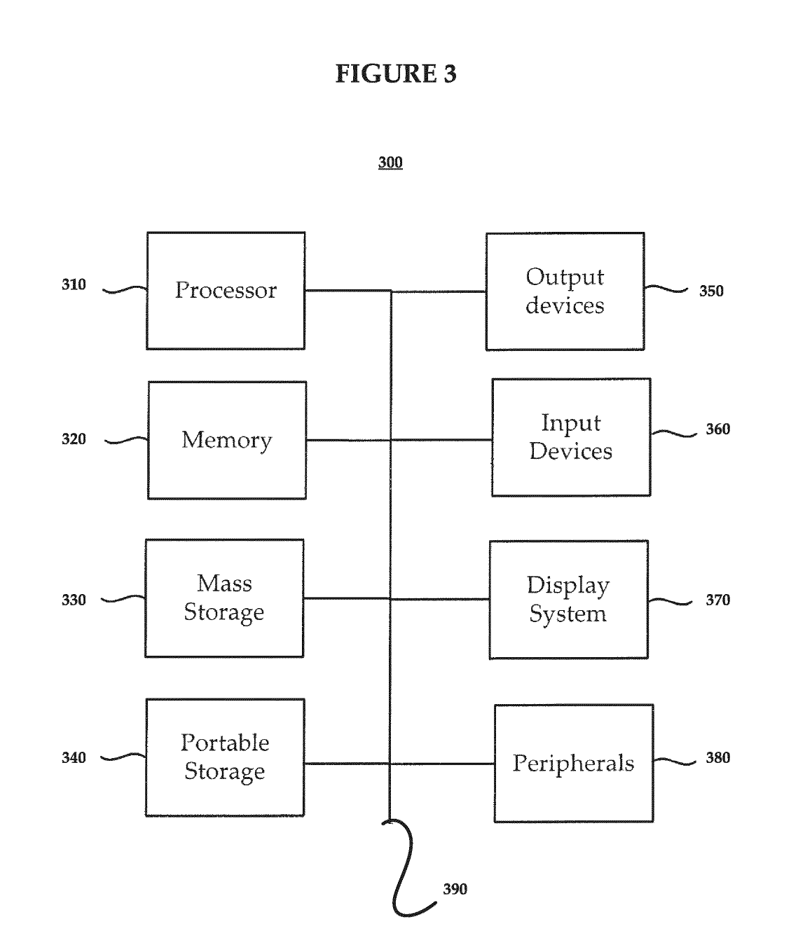

FIG. 3 illustrates a computing system 300 that may be used to implement an embodiment of the present invention. System 300 of FIG. 3 may be used to implement a computing device, network server, application server 150, and/or database operating in the context of the method of FIG. 1. The computing system 300 of FIG. 3 includes one or more processors 310 and memory 320. Main memory 320 stores, in part, instructions and data for execution by processor 310. Main memory 320 can store the executable code when in operation. The system 300 of FIG. 3 further includes a mass storage device 330, portable storage medium drive(s) 340, output devices 350, user input devices 360, a graphics display 370, and peripheral devices 380.

The components shown in FIG. 3 are depicted as being connected via a single bus 390. The components, however, may be connected through one or more data transport means. For example, processor unit 310 and main memory 320 may be connected via a local microprocessor bus, and the mass storage device 330, peripheral device(s) 380, portable storage device 340, and display system 370 may be connected via one or more input/output (I/O) buses.

Mass storage device 330, which may be implemented with a magnetic disk drive or an optical disk drive, is a non-volatile storage device for storing data and instructions for use by processor unit 310. Mass storage device 330 may store the system software for implementing embodiments of the present invention for purposes of loading software into main memory 320.

Portable storage device 340 operates in conjunction with a portable nonvolatile storage medium, such as a floppy disk, compact disk or Digital video disc, to input and output data and code to and from the computer system 300 of FIG. 3. The system software for implementing embodiments of the present invention may be stored on such a portable medium and input to the computer system 300 via the portable storage device 340.

Input devices 360 provide a portion of a user interface. Input devices 360 may include an alpha-numeric keypad, such as a keyboard, for inputting alpha-numeric and other information, or a pointing device, such as a mouse, a trackball, stylus, or cursor direction keys. Additionally, the system 300 as shown in FIG. 3 includes output devices 350. Examples of suitable output devices include speakers, printers, network interfaces, and monitors.

Display system 370 may include a liquid crystal display (LCD) or other suitable display device. Display system 370 may receive textual and graphical information, and process the information for output to the display device.

Peripherals 380 may include any type of computer support device to add additional functionality to the computer system. For example, peripheral device(s) 380 may include a modem or a router.

The components contained in the computing system 300 of FIG. 3 are those typically found in computer systems that may be suitable for use with embodiments of the present invention and are intended to represent a broad category of such computer components that are well known in the art. Thus, the computing system 300 of FIG. 3 may be a personal computer, hand held computing device, tablet device, telephone, mobile computing device, workstation, server, minicomputer, mainframe computer, or any other computing device. The computer may also include different bus configurations, networked platforms, multi-processor platforms, etc. Various operating systems may be used including Unix, Linux, Windows Mobile, or iOS. The steps of the method of FIG. 1 (and its various alternatives) may be performed by a module or engine stored on a computer readable storage medium (e.g., optical disc, memory card, etc.) comprising instructions executable by a processor of a computing device.

The above description is illustrative and not restrictive. Many variations of the invention will become apparent to those of skill in the art upon review of this disclosure. While the present invention has been described in connection with a variety of embodiments, these descriptions are not intended to limit the scope of the invention to the particular forms set forth herein. To the contrary, the present descriptions are intended to cover alternatives, modifications, and equivalents as may be included within the spirit and scope of the invention as defined by the appended claim and otherwise appreciated by one of ordinary skill in the art.

What is claimed is:

1. A computer-implemented method for ticket transfer payment, the method comprising:
initiating over a communications network a ticket transfer from a user to a recipient by way of a ticketing application;
receiving a user-specified payment amount for the ticket transfer in the ticketing application;
receiving by way of the ticketing application payment information from the recipient; and
processing the payment from the recipient on the ticketing application.

2. The method of claim 1, wherein the payment information includes a bank account number and a routing number.

3. The method of claim 1, wherein the payment information includes credit card information.

4. The method of claim 1, wherein the payment amount is selected by the user from a pre-defined list of payment amounts.

5. The method of claim 1, wherein the payment amount is specified manually by the user.

6. The method of claim 1, further comprising charging a fee for the payment processing.

7. The method of claim 6, wherein the fee is calculated as a percentage of the payment amount.

8. The method of claim 6, wherein the fee is charged to the user.

9. The method of claim 6, wherein the fee is charged to the recipient.

10. The method of claim 6, wherein the fee is charged to both the user and the recipient.

11. The method of claim 3, wherein the credit card information includes a credit card number, a credit card expiration date, and a credit card security number (CVV/VCV).

12. The method of claim 6, further comprising displaying transfer information, wherein the transfer information includes at least the payment amount, the fee amount, the total amount, and the name of the user to whom payment is authorized.

13. The method of claim 1, further comprising transferring the ticket to the recipient when the payment processing is complete.

14. The method of claim 1, further comprising aborting the transfer of the ticket to the recipient when the payment processing cannot be completed.

15. The method of claim 1, further comprising receiving payment deposit information from the user.

16. The method of claim 15, wherein the payment deposit information includes a bank account number and a routing number.
